(19) United States
(12) Patent Application Publication
(10) Pub. No.: US 2006/0265128 A1
(43) Pub. Date: Nov. 23, 2006

(54) Vehicle hijacking prevention system and method

(76) Inventor: Sherwin Miller, Carmel, CA (US)

Correspondence Address: PATRICK REILLY, P.O. BOX 7218, SANTA CRUZ, CA, 95061-7218, US

(21) Appl. No.: 11/339,004

(22) Filed: Jan. 24, 2006

Related U.S. Application Data
(60) Provisional application No. 60/647,358, filed on Jan. 26, 2005.

(51) Int. Cl. G01C 21/32; G06F 17/00

(52) U.S. Cl. 701/213; 701/208; 701/2

(57) ABSTRACT

A system and method for disabling a motorized vehicle are provided. In a first version a vehicle is tracked via GPS technology and monitored for adherence within scheduled parameters of movement. A radio controlled device resides within the vehicle and is configured to controllably disable and/or limits fuel input to an energy conversion-module of the vehicle. The locations, movement, speed, direction and one or more conditions of the vehicle may be monitored automatically or semi-automatically from a remote site. In a second embodiment a programmable limitation module monitors the location of the vehicle and limits the function of the vehicle when pre-programmed parameters are exceeded. The functional limitation imposable by the limitation module may include reduction or removal of access to a fuel supply.

### CO-PENDING APPLICATION

This nonprovisional patent application is a Continuation-in-Part to Provisional Patent Application No. 60/647,358, filed on Jan. 26, 2005. This nonprovisional patent application claims benefit of the filing and priority date of Jan. 26, 2005 of said Provisional Patent Application No. 60/647,358, and incorporates said provisional patent application herein in its entirety and for all purposes.

### FIELD OF THE INVENTION

The Present Invention relates to systems and methods of remotely disabling, managing and controlling motorized vehicles. More particularly, the Present Invention relates to systems and methods for deterring, preventing, or thwarting the unauthorized use, seizure or destruction of motorized vehicles, including those having passengers, volatile payloads, controlled substances and high-valued cargo.

### BACKGROUND OF THE INVENTION

The monitoring of vehicle location is provided in the prior art by various means, to include the application of global position systems (hereafter, “GPS”) to determine and report the location of a GPS transceiver attached to an identified vehicle. The prior art further enables communication with a driver of a motorized vehicle by means of light and radio waves, to include infrared transmissions, legally authorized commercial and citizen band radio frequency transmissions, and cellular phone transmissions. In addition, there are many applications in the prior art of remote control of electromechanical devices enabled by receipt by a wireless electronic device of messages or singles delivered within light or radio transmissions, to include telemetry based satellite control systems used by the National Aeronautics and Space Administration of the United States, as well as commercially available consumer products, such as an R-4500 wireless remote control system manufactured by Bright Image Corporation of Hillside, Ill., 60162-1603.

In recent years, the independence of commercial vehicles from remote control has permitted the unauthorized misuse of airplanes and other vehicles by terrorists and criminals. Perhaps most egregiously, terrorist attacks employing commercial aircraft have produced horrific losses of human life by inflicting severe structural devastation to buildings housing and proximate to high concentrations of civilians. The attack on the World Trade Center on Sep. 11, 2001 clearly underscores the ability of terrorists to successfully target and annihilate thousands of lives in a brief moment when large capacity vehicles are vulnerable to hijacking or misdirection. The potential for continued attacks of the same magnitude is alarmingly high, when one considers the three factors necessary to affect such an act: (1) seizure of a vulnerable transport vehicle; (2) an explosive potential enabled by the vehicle itself and/or cargo or fuel carried within the vehicle; and (3) a congregated population, population epicenter, and/or a structural target.

For example, in the case of the attack on the World Trade Center, two commercial jetliners were hijacked. Each jetliner had an onboard fuel capacity between 11,000 and 24,000 gallons. Upon impact with the World Trade Center, the fuel carried by each hijacked plane generated fireball explosions and heat that completely devastated two 110-story office buildings. Several thousand persons occupied the two towers that morning. When the hijackers flew the aircraft into the two towers, a combination of impact, fireball explosion, and resultant fire damage razed each building and ended thousands of lives. Despite the implementation of various security measures since the September 11, disaster, the potential for continued attacks remains indeterminate and of concern.

For example, thousands of transport vehicles such as gasoline and propane fuel delivery trucks traverse a network of public roads and highways every day. These transport vehicles stop at numerous refineries, regional fuel storage and loading depots, and retail service stations. Many of these unprotected vehicles remain very vulnerable to unauthorized use or even seizure by terrorists. Unlike the commercial aircraft used in the September 11, attacks, a single individual with minimal training can be quite capable of successfully hijacking and operating a truck. Further, a single, fully-loaded gasoline delivery tank truck with trailer, such as those commonly used between loading depots and retail stations, may carry up to 4,000 gallons of liquid propane or 9,500 gallons of gasoline. The explosive potential of such a truck could be realized by, for example, detonation of a single stick of dynamite fastened to the side of the vehicle. The resultant explosion and residual effects can have the capacity to devastate major structures nearby and potentially cause hundreds, or even thousands, of injuries and deaths. A coordinated attack portends a catastrophe of immense proportions. For example, a dozen trucks might be simultaneously seized and may be used to attack a number of different cities. In addition to blast and fire damage, exploding fuel trucks may widely disseminate radioactive materials placed on or in the trucks. Radioactive gases and smoke resulting from the blast and intense fire may well contaminate vital sectors of major metropolitan areas and many miles of the surrounding geographic areas.

Variant themes of the foregoing examples include an attainable disaster potential for cargo vehicles carrying hazardous material such as dangerous chemicals or explosives; and for passenger vehicles, such as busses, wherein lives are at stake and passengers are vulnerable to hostage situations. In addition, cargo vehicles carrying valuable material such as precious metals, financial documents, money, historical objects, or art work may be vulnerable to theft or trespass to chattel and used in attempts top extort changes to governmental policy or activity.

Accordingly, there is a real and immediate need for a system and method to effectively prevent or thwart such misuse, attacks or threats to possessions or persons. It is the primary object of the Method of the Present Invention to provide methods and tools to support the remote control interdiction of hijacking or unauthorized use of motorized vehicles. This and other objects of the Present Invention will become clear from an inspection of the detailed description of the Present Invention and from the appended claims.

### SUMMARY OF THE INVENTION

Towards these objects and other objects that will be made obvious in light of the present disclosure, the Method of the Present Invention provides a new and improved system and method for preventing or impeding the unauthorized use, seizure and/or conversion of vehicles into tools of criminality or terrorism. The features and functionality of the Present Invention may be broadly applied in various alternate preferred embodiments of the Method of the Present Invention. For example, various aspects of the Present Invention may be directed to vehicles carrying financially valuable, culturally significant, or volatile payloads; and/or to passenger vehicles, such as busses, limousines, and privately-owned vehicles.

A first preferred embodiment of the Present Invention provides a control system of a motorized vehicle, where the control system includes (a.) means for determining the location of the vehicle, (b.) means for comparing the location of the vehicle against a set of limitations, and (c.) means for impairing the mobility of the vehicle, whereby movement of the vehicle is constrained when the vehicle's location exceeds at least one parameter, e.g., trespassing outside of a permitted geographic zone or geographic boundaries of a route of travel.

Certain alternate preferred embodiments of the Method of the Present Invention provide a control system of a motorized vehicle, where the motorized vehicle has a fuel source and an energy conversion module. The control system may include (a.) means for determining the location of the vehicle, (b.) means for comparing the location of the vehicle against a set of limitations, and (c.) means for limiting access to fuel of the fuel source by the energy conversion module, whereby movement of the vehicle is constrained when the vehicle's location exceeds at least one parameter.

Certain still alternate preferred embodiments of the Method of the Present Invention provide a control system that include (a.) a controller, the controller programmed to controllably impede the mobility of the vehicle, (b.) a radio transmitter, the radio transmitter for transmitting information identifying the vehicle, and (c.) a radio receiver, the receiver configured to receive instructions via radio wave, the instructions for directing the controller to impede the mobility of the vehicle.

Certain other alternate preferred embodiments of the Method of the Present Invention provide a method to controllably impede mobility of a motorized vehicle, the method including (a.) establishing geographic boundaries of a route of travel for the vehicle, (b.) monitoring the location of the vehicle, and (c.) impeding the mobility of the vehicle when the vehicle approaches or exceeds the geographic boundaries of the route of travel.

Certain yet alternate preferred embodiments of the Method of the Present Invention provide a computer-readable medium on which are stored a plurality of computer-executable instructions for directing a controller to impeding the mobility of the vehicle as directed and/or when directed by remote control.

Further, certain additional alternate preferred embodiments of the Method of the Present Invention may be highly scalable. For example, various aspects of the Present Invention may be implemented on a multinational level, a national level, a regional level, local level or on an individual basis. Such implementations may provide for remote monitoring and selective action taken to prevent or intervene in seizure activities. These actions may be selectively taken with respect to the entire fleet, a portion of the fleet, or an individual truck in the fleet.

With respect to an individual implementation, i.e., on a per-vehicle basis, local monitoring and selective action may be taken in a manual fashion, by remote intervention or by an automated process. In a manual action example, the vehicle operator might assess a situation as indicative of a high risk of a hijacking attempt and selectively disables the engine by means of a control system designed in accordance with the Method of the Present Invention. Alternatively, or additionally, a remote operator of an alternate preferred embodiment of the Present Invention might detect the geographic proximity of the vehicle to an edge of a permitted travel zone or route of travel, whereby the remote operator might transmit a signal by radiowave to a controller of the instant system to remove access to fuel to a motor of the vehicle. In an example of an automated intervention, an onboard computer of the instant system might monitor vehicle and route conditions, and automatically triggering responsive measures based on, for example, situational dynamics. Various other aspects of the Present Invention provide for various combinations of the aforedescribed aspects. For example, the Present Invention may be directed to both remote and local installations of various components of the Present Invention, as hereinafter illustrated.

Still further, the Present Invention may provide layers of redundancy against an attack. In contrast to the prior art, which are typically limited to a single-point solution for preventing an attack, the Present Invention provides a comprehensive solution with definitive proactive and responsive measures for each stage in a seizure scheme. For example, various aspects of the Present Invention may provide the functionality necessary to prevent seizure of the vehicle by overtaking an operator of the vehicle and may also provide the functionality necessary to thwart a relocation of the vehicle for spurious purposes if the operator is incapacitated or is away from the vehicle. Various aspects of the Present Invention may further provide for component redundancy and may permit activation of secondary components to augment primary component functionality and/or to provide redundancy in case of primary component failure. Finally, such components may be activated manually or automatically, as well as locally or remotely, providing a comprehensive, complete solution to the aforedescribed issue.

Various aspects of the Present Invention may provide for, but are not limited to, disabling a vehicle; monitoring a vehicle or fleet of vehicles; alerting various parties such as emergency response teams and bystanders; and vehicular remobilizing measures.

In various aspects of the Present Invention, disabling a vehicle may include, for example, one or more various methods of engine or vehicle disablement. A primary method for disabling both diesel engine vehicles, gasoline vehicles and propane vehicles may include cutting off the fuel supply to the engine. Secondary methods, which may be activated manually or automatically, may include, for example, activating air brakes; locking the steering mechanism, interrupting an air supply; disrupting an ignition system; disrupting a starter electrical supply; interrupting a power supply; and/or locking a steering assembly.

In various aspects of the Present Invention, system operations and equipment may include, for example, gasoline or diesel engine disablement by closure of fuel supply line valves; interruption of diesel engine air intake; disruption of gasoline engine ignition system and electrical supply to the starter system or subsystem; disruption of the power supply and/or steering assembly; and software encoded instructions provided in a media readable by a computer, e.g., a controller, of the Present Invention.

With respect to gasoline and diesel engine disablement by closure of a fuel supply line valves, an aspect of the Present Invention may be adaptable for use with diesel, gasoline, or other types of engines. Fuel line valves hardened to better endure explosive blasts might, for example, be installed in secure locations in a fuel line between the fuel tank(s) and the engine. Immediate closure of the valve(s) with resultant termination of fuel flow to the engine can be initiated by utilizing various methods, as hereinafter described.

With respect to interruption of diesel engine air intake, another aspect of the Present Invention, air supply to the engine may be stopped, for example, by closure of a valve on the air intake manifold.

With respect to disruption of the gasoline engine ignition system and the electrical supply to the starter, yet another aspect of the Present Invention, power may be interrupted to various components such as the distributor or starter. For example, a relay breaker switch or other device may be activated to interrupt a power supply via various means, as hereinafter described.

With respect to disruption of the power supply and or locking the steering assembly, various devices such as an onboard computer may be used to activate components for disruption of the power supply (as heretofore described), resulting, for example, in locking of the steering assembly of the vehicle.

Various software programs may also be used in conjunction with, or as part, the Present Invention. Various functions may be carried out with respect to the Present Invention. For example, software may facilitate disablement of the vehicle; monitoring of fleet operations; remobilization of vehicles; warnings to government agencies; warnings of danger in proximity to endangered or disabled vehicles; and disablement of onboard computer systems.

The preceding systems operations and equipment are discussed in greater detail hereinafter. The foregoing and other objects, features and advantages will be apparent to one of ordinary skill in the art from the following description of the preferred embodiment of the Present Invention as illustrated in the accompanying drawings.

### BRIEF DESCRIPTION OF THE DRAWINGS

These, and further features of the Present Invention, may be better understood with reference to the accompanying specification and drawings depicting the preferred embodiment, in which:

FIG. 1 illustrates a schematic of a first preferred embodiment of the Method of the Present Invention, or first method;

FIG. 2 illustrates a second preferred embodiment of the Present Invention, or a general vehicle hijacking prevention system, or first system, that enables the first method of FIG. 1;

FIG. 3 illustrates in block diagram of various components of an alternate preferred embodiment, or second system, of the general vehicle hijacking prevention system of FIG. 2;

FIG. 4 illustrates a method for preventing a vehicle hijacking, according to another alternate preferred embodiment of the Present Invention, and general vehicle hijacking prevention system of FIG. 2;

FIG. 5 illustrates another method for preventing a vehicle hijacking, according to a yet alternate preferred embodiment of the. Present Invention and employing the general vehicle hijacking prevention system of FIG. 2;

FIG. 6 illustrates a method for remobilizing a vehicle, according to an alternate preferred embodiment of the Method of the Present Invention of the general vehicle hijacking prevention system of FIG. 2;

FIG. 7 illustrates a schematic of another vehicle hijacking prevention system, according to a still other alternate preferred embodiment of the Present Invention;

FIG. 8 is a process chart comprising a flowchart of a software program that enables the control of mobility of a vehicle that may be enabled by the first system of FIG. 2; and

FIG. 9 is a detailed schematic of the computer of the general vehicle hijacking prevention system of FIG. 3.

### DETAILED DESCRIPTION OF A PREFERRED EMBODIMENT

Various aspects of the Present Invention may be described in the general context of computer-executable instructions, such as program modules, executed by one or more computers or other devices. Generally, program modules include routines, programs, objects, components, data structures, and so forth, that perform particular tasks or implement particular abstract data types. Typically the functionality of the program modules may be combined or distributed as desired in various embodiments. In a distributed computing environment, program modules may be located in both local and remote computer storage media, including memory storage devices.

Such computer-executable code, such as program modules, may be implemented on, or associated with, various computer-readable media. Various computing devices typically include at least some form of computer-readable media. Computer-readable media can be any available media that can be accessed by such computing devices. Communication media typically embody computer-readable instructions, data structures, program modules, or other data in a modulated data signal such as a carrier wave or other transport mechanism which may be transported via, for example, a communication link, and include any information delivery media. The terms “modulated data signal” or “signal” are used herein to mean a signal that has one or more of its characteristics set or changed in such a manner as to encode, encompass, or associate information in or with the signal. By way of example, and not limitation, communication media include wired media such as a wired network or direct wired connection, and wireless media such as acoustic, UHF, VHF, RF infrared, infrared, and other wireless media. For example, a data transfer may be performed using communication means that may include blue tooth, RF, infrared, ultrasonic, GPS, cellular, radio, or other conventional or heretofore unknown remote communication means. Combinations of any of the above should also be included with the scope of computer-readable media. With reference now to the drawings, wherein like items are referenced with the same numerals, the Present Invention is generally described. The following examples are illustrative only, and are not limiting in any way with respect to the scope or application of the Present Invention.

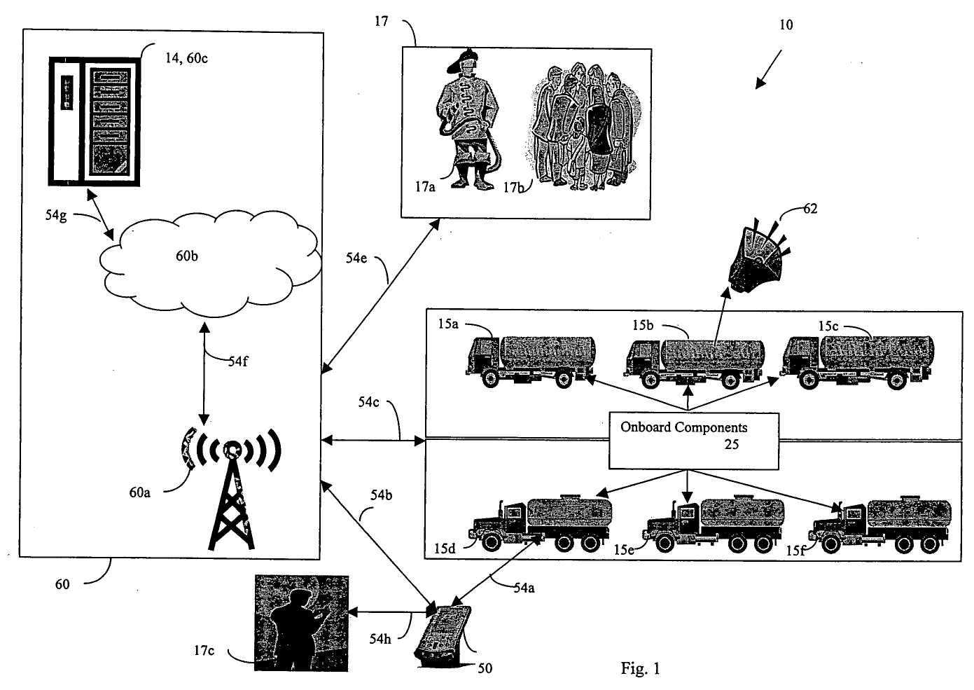

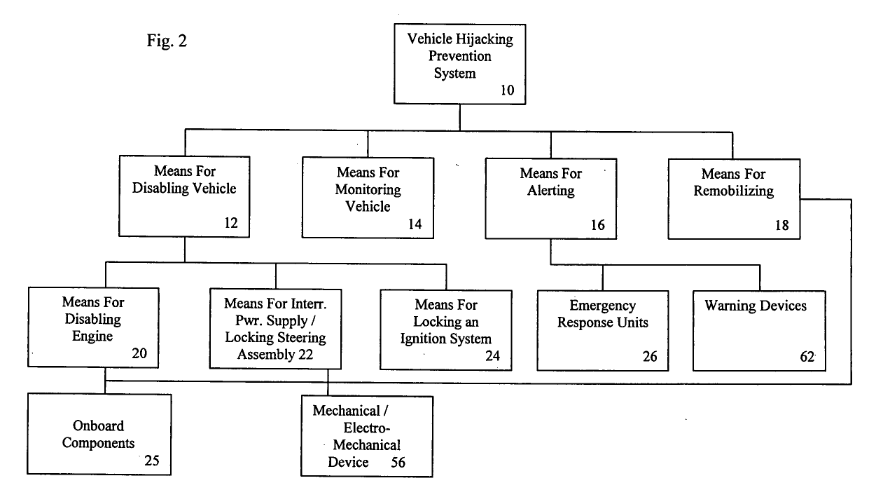

Referring now generally to the Figures and with particular reference to FIGS. 1 and 2 of the Present Invention, there is generally shown first preferred embodiment of the Method of the Present Invention (hereafter “first method”) providing a vehicle hijacking prevention system 10 (hereafter “first system 10”). The first system 10 may include, for example, one or more of the following components: means for disabling the vehicle 12; means for monitoring a vehicle 15 in individuality or of a fleet of vehicles 15a-f; means for alerting 16 various parties 17 such as emergency response teams 17a or bystanders 17b; and means for remobilizing 18 a vehicle or fleet of vehicles. In various aspects of the Present Invention, various components and/or subcomponents may be independently implemented; implemented with other components; or partially integrated with other systems, subsystems, or components. For example, various subcomponents of means for remobilizing 18 may also be used by means for disabling a vehicle 12, as hereinafter illustrated and described.

Means for disabling a vehicle 12, may include, for example, means for disabling the engine 20; means for interrupting a power supply to the vehicle and/or locking a steering assembly 22; and means for locking an ignition system 24 of the vehicle. Disabling the engine may be brought about in a number of ways.

Some examples include, but are not limited to, cutting off the fuel supply to the engine, which will generally cease to run within a predetermined time; for example, thirty seconds of such action. The approach may be effective with various types of engines, including gasoline and diesel. Occasionally, a diesel engine may continue to run on its own crank case oil for brief periods of time after depriving the engine of fuel. Stopping the air supply to the engine may also be an effective disablement tool. Such a measure may be taken concurrently in cutting of the fuel supply, or used as a primary or redundant fallback measure; for example, in the case of diesel engines or gasoline engines. Air supply interruption can be achieved, for example, by using an electrically operated flapper valve in the air intake manifold (described in detail hereinafter). various optional aspects of the Present Invention. For example, the flapper valve could be used simultaneously with the solenoid valve in the fuel line to stop both the air supply and the fuel supply to the engine. Another tactic may include disrupting or locking the ignition system, for example, in gasoline engines. Yet another tactic may include disrupting an electrical supply. A skilled artisan will note that the foregoing may be used alone or in combination, together with components and subcomponents implemented independently; integrally; or partially integrated, as exemplified hereinafter.

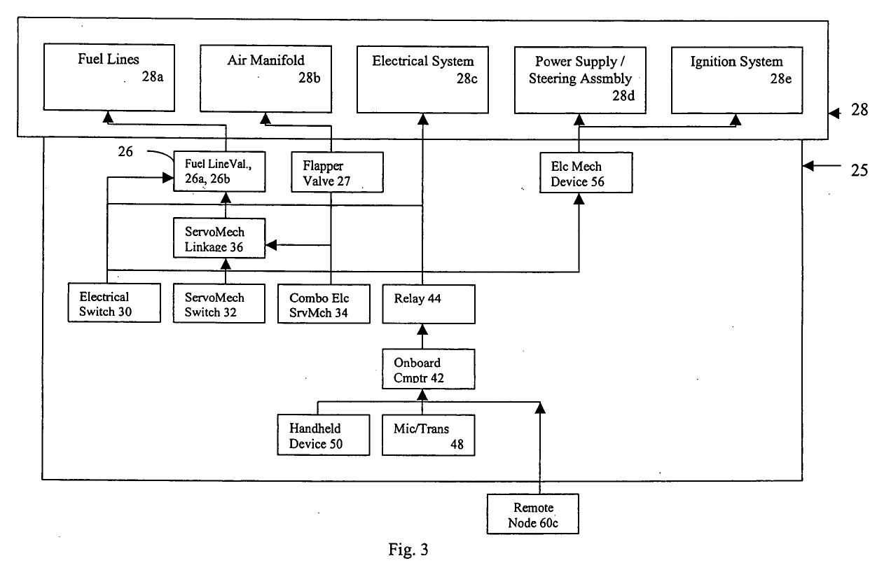

In various aspects of the Present Invention, cutting off the fuel supply to disable the engine of the vehicle may be accomplished via a number of means. For example, and referring now generally to the Figures and with particular reference to FIG. 3 and continuing reference to FIGS. 1 and 2, in various aspects of the Present Invention, the first system 10 of FIG. 2 may comprise a vehicle 15 configured with a second preferred embodiment of the Present Invention (hereafter “second system 25”) comprising various vehicle elements and systems 28-42, 44 & 56 (including fuel lines 28a; air manifold 28b; electrical system 28c; power supply and/or steering assembly 28d; and ignition system 28e) said communication direct, indirect, or both. The second system may be in mechanical communication, in electrical communication, or a combination thereof, with one or more components 14, 48, 50, 60a systems or devices. For example, onboard components 25 may include fuel line valves 26, such as a solenoid valve; and an electrical switch 30, implemented, for example, as/a foot-pressure electrical switch (not shown). The fuel line valves 26 may be installed, for example, in predetermined, secure locations in the fuel line between at least one fuel tank and the engine. The driver of the vehicle may terminate the fuel flow to the engine by closing the fuel line valve 26; for example, by selectively pressing the electrical switch 30 that may send a signal to the fuel line valve 26 such as a valve (not shown), actuating closure thereof.

In various aspects of the Present Invention, a servo-mechanical switch 32 implemented, for example, as a foot-pressure switch (not shown), may be used to close a fuel line valve 26, wherein fuel line valve may be, for example, a primary fuel line valve 26a and/or a secondary fuel line valve 26b mechanically associated for example, with a servo-mechanical linkage 36. As heretofore mentioned, the servo-mechanical switch 34 may be implemented as a single solution, may be implemented together with the electric switch 30, and may be implemented as a combined electrical and servo-mechanical switch 34, such as a foot-pressure combined electrical and servo-mechanical switch (not shown). In various scenarios, the driver, for example, may press the combined electrical and servo-mechanical switch 34, which may activate to close an associated primary fuel line valve 26a, shutting off fuel flow to the engine. If the primary fuel line valve 26a fails to close, a secondary fuel line valve 26b may be closed by servo-mechanical action and the associated servo-mechanical linkage 36. Alternatively, pressing the combined electrical and servo-mechanical switch 24 may activate both, closing the primary fuel line valve 26a and the secondary fuel line valve 26b, respectively.

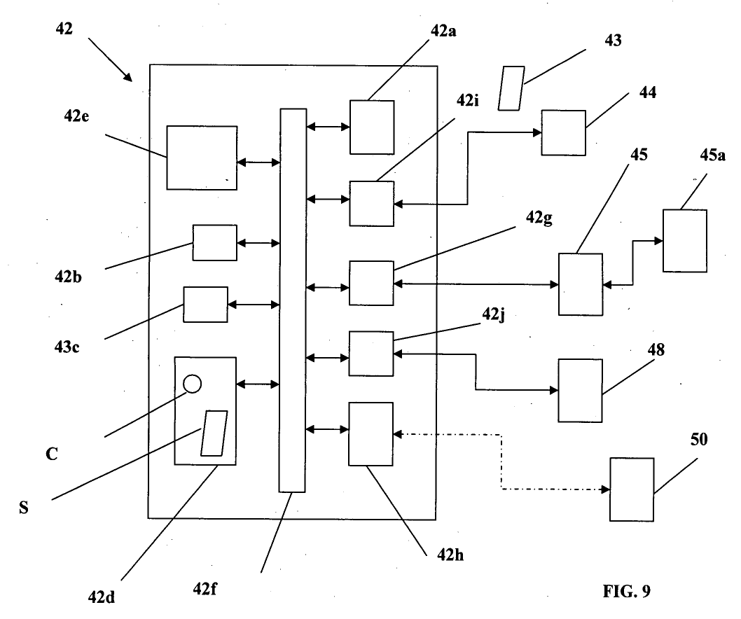

In various other aspects of the Present Invention, an onboard computer 42, such as a microchip having computer-executable instructions, for example, and a relay 44 may be used to activate closure of fuel lines valves 26. The computer 42 may be coupled with an air brake valve activation switch 45, as per FIG. 9, wherein the computer 42 causes one or more air brakes (not shown) of the vehicle 15 to engage and halt the rotation of wheels of the vehicle 15. In one exemplary preferred embodiment of the Method of the Present Invention, an electrically activated air brake valve 45a is installed one or more air pressure lines (not shown) of the vehicle 15 and is further communicatively coupled with an air brake valve activation switch 45. The air brake valve activation switch 45 is communicatively coupled with the air brake valve 45a and the computer 42, wherein the activation of the air brake valve 45a is thereby affected as directed by the computer 42. Activation of the air brake valve 45a causes one or more air brakes of the vehicle 15 to impede or halt the mechanical rotation of one or more wheels (not shown) of the vehicle 15.

The computer 42 may, as shown in FIG. 9, further include a media reader 42a, wherein the media reader 42a is configured to read, and communicate to the computer 42, software encoded instructions from a computer-readable media 43. The software encoded instructions stored on the computer readable media 43 may be authored in various alternate preferred embodiments of the Method of the Present Invention to direct the computer 42 to actualize one or more of the steps, processes, or actions disclosed herein. For example, the onboard computer 42 may be programmed to trigger the relay 44, which, in turn, closes the fuel line valve 26 within a predetermined time or a time indicated in the software encoded instructions read from the computer-readable media 43. The onboard computer 42 may be activated in one or more of a variety of ways, to include in certain alternate preferred embodiments of the Method of the Present Invention by the execution by the computer 42 of software encoded instructions read from the computer-readable media 43. An onboard device 46 such as a voice activated microphone/transmitter 48 may be used to transmit a signal to the onboard computer 42 for closure of the fuel line valves 26. A handheld device 50 such as a voice activated microphone/transmitter 48 may be particularly useful in situations where the driver is away from the vehicle, yet within effective transmission distance to the onboard computer 42, whereby, for example, the handheld device 50 such as a personal digital assistant (hereafter, “PDA”), may be activated by a driver 17c by activating a signal via use of a command such as a voice command or by pressing an activatable button (not shown) to send a signal via, for example, a communication link 54a to the onboard computer 42 to activate the relay 44. Alternatively, the handheld device 50 may comprise various components such as, but not limited to, a key fob, radio, or cell phone, with or without voice activation features.

In other aspects of the Present Invention, the onboard computer 42 may be selectively programmed, preprogrammed, or reprogrammed to monitor the route of the vehicle. For example, the onboard computer 42 may interact with a satellite GPS (not shown) via a communication link such as 54c to track the location of the vehicle via triangulation or other methods and compare its location to the programmed route. If the vehicle exceeds one or more geographic limitation parameters constraining or defining a programmed route, the onboard computer may automatically trigger closure of the fuel line valve(s) 26. A radio transceiver 42c, comprising a radio receiver and a radio transmitter, of the prevention system 10 provides information identifying the vehicle 15 to the remote monitoring means 14. The radio receiver 42c is further configured to receive instructions via radio wave from the radio tower 60a, the instructions for directing the computer 42 to impede the mobility of the vehicle 15. As per FIG. 9, the computer 42 further comprises a memory 42d that stores the geographic limitation parameters and may be used by the computer 42 to determine whether a GPS reading received by the GPS reader 42a indicates that the vehicle 15 exceeds the geographic limitation parameters. The geographic limitation parameters may be received by the computer 42 via wireless transmission media or from the computer-readable medium 43.

In still other aspects of the Present Invention, the onboard computer 42 may also function as communication media to receive a signal to disable the engine from a remote source. The signal may, for example, comprise digitized data and may be propagated across'one or more communication link(s) such as communication links 54a-c, 54d-h including, but not limited to, a VHF link, UHF link, or other carrier wave, as well as one or more communication media 60 such as a wired or wireless network, or combination thereof. For example, wireless media 60a, the Internet 60b, and a node on a network 60c, such as means for monitoring 14, as hereinafter described, may be utilized. The remote signal may be triggered, for example, by various stimuli. For example, means for monitoring 14, may send a signal to the onboard computer 42 via communication link 54g, the Internet 60b, the wireless medium 60a, such as the radio tower 60a, and the communication link 54c.

Means for interrupting a power supply to the vehicle 22 may include, for example, the electrical switch 30 or combination electrical/servo-mechanical switch 34, implemented for example, by an electric switch 30; a servo-mechanical switch 32; a combination servo-mechanical switch 34; on onboard computer 42; an onboard signal activation device such as a microphone/transmitter; or a handheld device 50, as generally described heretofore. For example, a hand switch or foot switch in the vehicle may, for example, send a signal to an electro-mechanical device 56, such as a system, subsystem, or component, to interrupt the power supply 28d to the vehicle and thus, for example, disable the power steering capabilities of the vehicle and/or other systems, subsystems, or components. In various aspects of the Present Invention, such a switch may be selectively set to prevent an initial power source to the vehicle when attempting to start the vehicle. This may be useful, for example, for circumstances in which the drive of the vehicle must leave it unattended.

Means for locking the ignition system 24 may include, for example, the mechanical or electromechanical device 56 such as a locking device to lock or unlock the ignition system 24.

Means for locking the ignition system 24 may be activated via various methods and components, as heretofore exemplified. For example, the onboard computer 42 or the handheld device 50 may trigger an activation device (not shown) for actuating the locking device (not shown). In other aspects of the Present Invention, a key fob or handheld device 50 may include, for example, a microchip for transmitting a signal via a communication link such as 54a to the onboard computer 42, signaling authorization for startup or enablement of various vehicle components and systems, including, for example, the ignition system.

Means for monitoring a vehicle 15 or fleet of vehicles may be carried out locally or remotely. For example, a heretofore described, local monitoring may utilize the onboard computer 42 to monitor the truck's route and compare it to a preprogrammed, authorized routes. Deviations from the preprogrammed route may result in corrective, disabling, notifying or other determinative actions. For example, startup of the truck and movement from a designated spot may be sensed by the onboard computer 42, which may, in turn, activate means for disabling the engine 20 and may send a signal via a communication link 54 to the handheld device 50 which may audibly, visually, or otherwise notify the driver 17c. Additionally or alternatively, in various aspects of the Present Invention, the onboard computer 42 may send a signal to and activate means for alerting 16. Means for alerting 16 may include, for example, a siren, loudspeaker, or other warning devices 62, warning bystanders to prospective danger via, for example, a prerecorded message. For example, the message may be continuously broadcast alerting persons to stay away from the vehicle and to evacuate the area. Further, devices such as flashing red lights and a siren may provide visual and audible alerts to warn people in the area. In various aspect of the Present Invention, the broadcasts or other alerts maybe disable, for example, by. entering a code into the onboard computer via various devices such as the handheld device 50.

In still other aspects of the Present Invention, means for alerting 16 may include 0 the onboard computer 42, which may be used, inter alia, to send a signal via, for example, communication link 54c, to the Internet 60b, to the remote node 60c, and via communication link 54e to various emergency response teams 17a.

In yet other aspects of the Present Invention, the onboard computer may self-monitor and monitor various other onboard components 25 for various conditions such as malfunction or tampering. Upon detection of such a condition, appropriate action may be taken. For example, a signal may be sent to the handheld device 50 alerting of component nonconformity or the onboard computer 42 may trigger closure of the fuel line valves 26 or take other actions in cases of tampering.

Remote means for monitoring 14 may be configured, for example, as the node 60c accessible, for example, via the Internet 60b. The node 60c, such as a server, may be programmed, for example, to monitor the route of one or more vehicles 15a-e, and compare preprogrammed, authorized routes to their actual routes, as determined, for example, by the node 60c in conjunction with a GPS service. Upon deviation from the authorized routes, various predetermined actions may be taken. For example, the node 60c, may send a signal via communication link 54e to alert emergency response teams 17a, government agencies, and the like to the fact of a “hijacking in progress” and to alert such teams and agencies to the precise location of the vehicle. The node 60c may send a signal via various communication links 54 and communication media 60 to the onboard computer 42 of one or more vehicles, which, in turn, may disable various parties (shown in phantom at 72) may be taken. After disabling the vehicle, the vehicle may be remobilized (shown in phantom at 74) by local means, remote means, or a combination thereof, as heretofore exemplified, and the method 64 ends at 76.

The step of disabling the vehicle at 68 may be accomplished via a variety of ways. For example, remote devices such as a server monitoring a fleet of vehicles, as exemplified in FIG. 1 as 60c, local devices, such as onboard components 25 shown in FIG. 1, or a combination of the same may be employed, as heretofore exemplified.

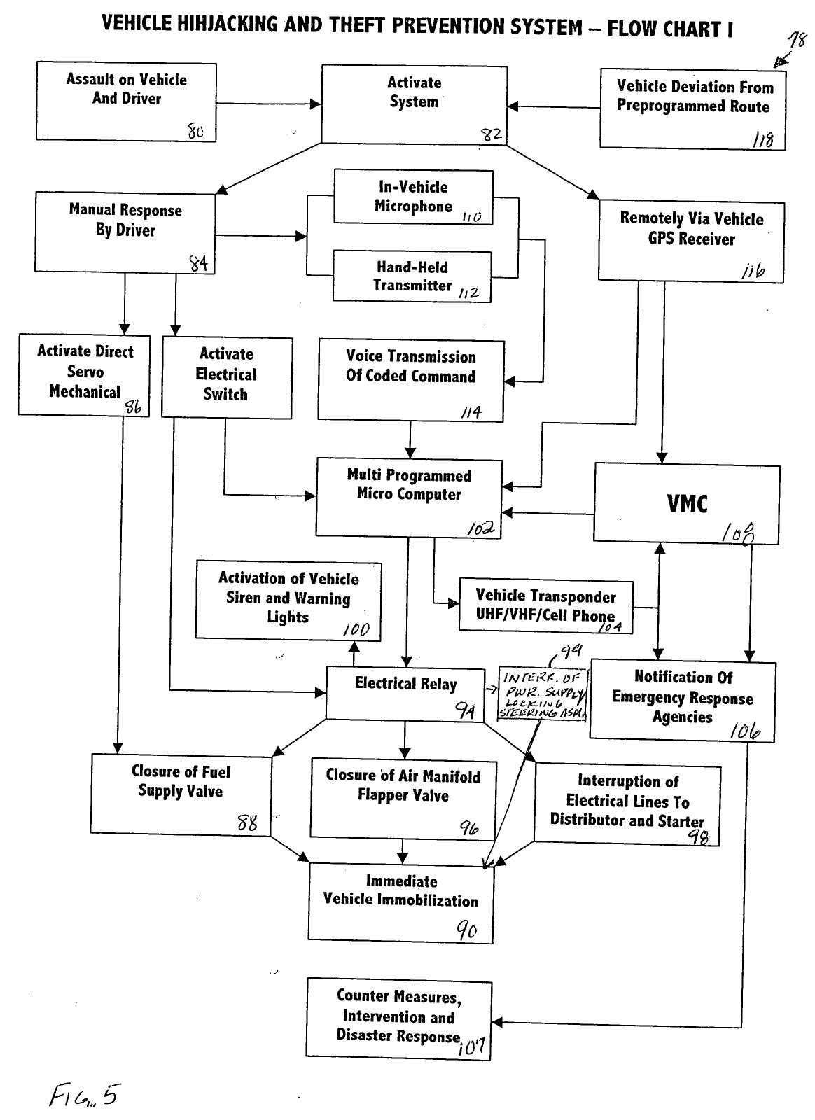

Referring now generally to the Figures and with particular reference to FIG. 5, there is shown generally at 78 a flow chart of a vehicle hijacking and theft prevention system. For example, after an assault on a vehicle (and driver) has occurred at 80, the system may be activated at 82. Activation may, for example, take the form of a manual response by the driver at 84. The manual response may, for example, include activation of a direct servo-mechanical device at 86, resulting in closure of a fuel supply valve at 88 and immediate vehicle immobilization at 90. Other manual responses include, for example, activating an electrical switch at 92, which may, for example, activate an electrical relay at 94, activating closure of the fuel supply valve at 88, closure of an air manifold flapper (shown as 27 in FIG. 3) valve at 96, interruption of electrical lines to a distributor and starter at 98, interruption of the power supply 99 (resulting, for example, in locking of the steering assembly); or a combination of the foregoing, each, all or a combination of which may result in immediate vehicle immobilization at 90. The electrical relay may also, for example, activate siren, warning lights or similar devices at 100. Alternatively or additionally, activating the electrical switch at 92 may, for example, signal an onboard computer such as a multi-programmed microcomputer at 102, which may in turn, activated the electrical relay at 94. The microcomputer may also send a signal via, for example a vehicle transponder and carrier, such as UHF, VHF, or cell phone, to directly notify emergency response agencies at 106 or indirectly notify such agencies via a signal to a vehicle monitoring center at 108, which may comprise, for example, manual means, automated means, or a combination thereof, as a node 60c server and response team. The VMC may, in turn, notify the emergency response agencies at 106, send a signal to the microcomputer at 102, and/or take various other actions, such as counter measures, intervention and disaster response at 107.

Manual response by the driver at 84 may also include, for example, initiating vehicle immobilization via an in-vehicle microphone at 110 or hand-held transceiver at 112, either of which (or both) may communicate, for example, a coded signal, such as a voice command, at 114 to the microcomputer at 102.

In various aspects of the Present Invention, the system may also be activated at 82 remotely. For example, a signal may be sent via a remote source and a GPS receiver 42b to the vehicle at 116, for onward transmission, for example, to the VMC at 108 or the microcomputer at 102. The GPS receiver 42b is communicatively coupled with the computer 42 and provides GPS data received via wireless transmissions to the computer 42.

As heretofore describe, the vehicle may also be locally or remotely monitored for deviation from a preprogrammed route, and, upon such a deviation, the system may be activated at 118.

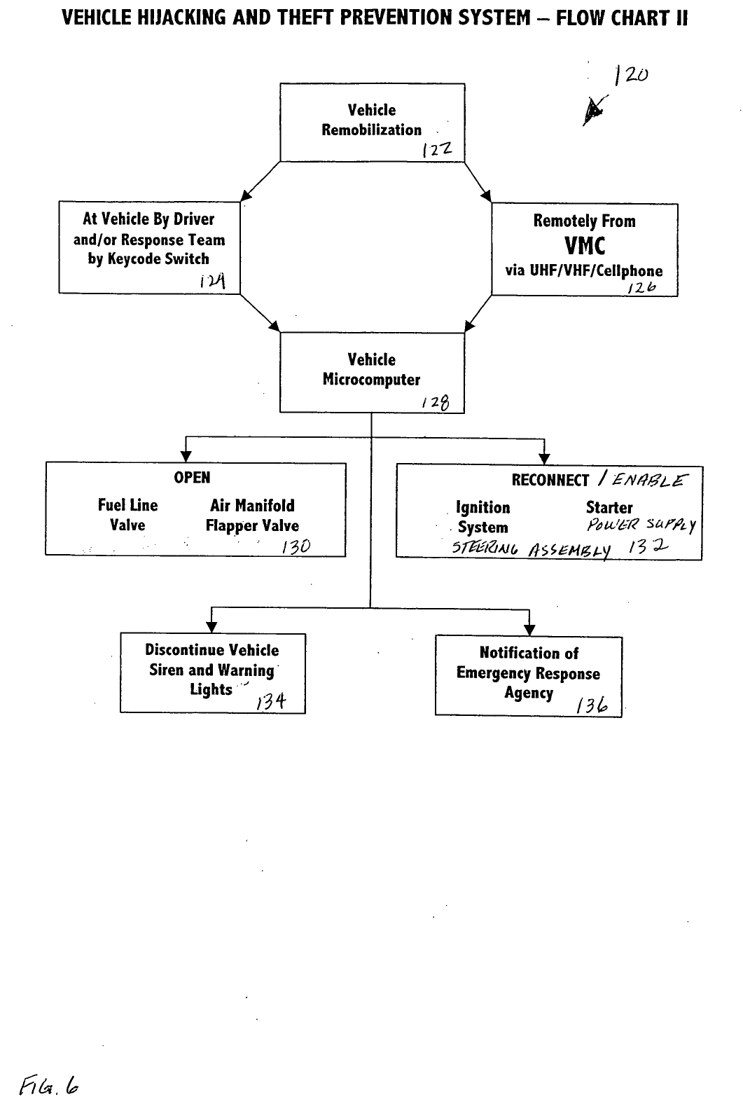

Referring now generally to the Figures and with particular reference now to FIG. 6, there is shown generally at 120 a flowchart of a system for remobilizing a vehicle after disabling the vehicle. The vehicle remobilization process may begin locally, for example, by use of a keycode switch or other means by the driver or a response team at 124. In various aspects, the remobilization process may alternatively or additionally begin remotely by, for example, transmission of a signal via the VMC, a radio, cell phone or other transceiver, and a communication link such as UHF, VHF, at 126. The manually-generated or remotely-generated signal may then be sent on to the vehicle microcomputer at 128. Upon receipt of the signal by the vehicle microcomputer at 128, one or more actions may be taken. For example, such actions include, but are not limited to, opening the fuel line valve and/or opening the air manifold flapper valve at 130; reconnecting and/or enabling the ignition system; the steering assembly; the starter; and the power supply at 132; discontinuing vehicle siren and warning lights at 134; and notifying emergency response agencies at 136.

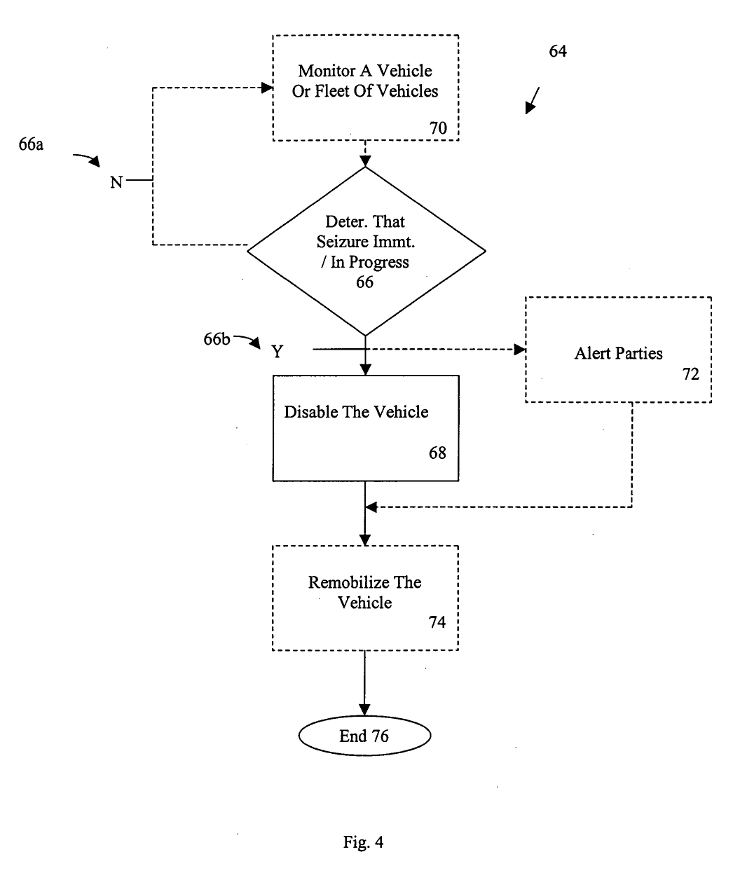

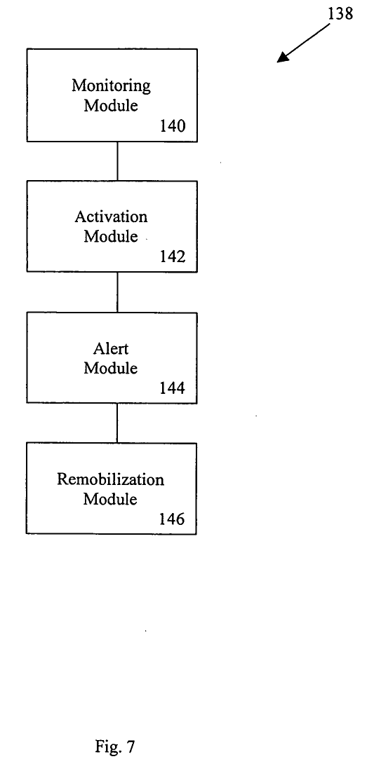

Referring now generally to the Figures and particularly to FIG. 7, and with continuing references to FIGS. 1-4, there is shown generally at 138 a system for preventing or inhibiting seizure of a vehicle. The system 138 may be implemented, for example, as software, hardware or a combination thereof. Some implementations include, but are not limited to, implementation in a microcomputer or microchip; implementation in a remote server, such as the node 60c shown in FIG. 1; and/or implementation in a distributed network. The system may include, for example, one or more of the following modules. a monitoring module 140 for monitoring a vehicle or a fleet of vehicles; an activation module 142 for initiating an action or signal for disabling a vehicle 15; an alert module 144 for alerting various parties; and a remobilization module 146 for remobilizing a vehicle, fleet of vehicles, or component(s) of a vehicle. The modules 140-146 may be implemented independently, in an integrated fashion, or in a partially integrated fashion. The monitoring module 140 may, for example, reside on a server such as node 60c accessible to, for example, the Internet 60b and/or wireless communication media 60a, and may be utilized to monitor the movement of a vehicle or fleet of vehicles via, for example, communicatively coupling the GPS receiver 42b with a geosynchronous earth satellite based GPS system (not shown), and compare such movement against an authorized route schedule (as heretofore exemplified). In another example, the monitoring module may be embedded in, for example, the onboard computer 42.

Upon deviation from the authorized route, the activation module 42 may be invoked by, for example, the monitoring module 140 to send a signal such as an instruction to trigger some action. For example, both the monitoring module 140 and the activation module 142 may be integrated into the onboard computer 42. The monitoring module may generate a signal communicated to the activation module 142. Upon receipt of said signal, the activation module 142 may send a signal to a fuel line valve 26 such as a solenoid valve, to activate closure of the fuel line valves 26.

In yet another example, the monitoring module 140 may be associated with a remote node such as node 60c, accessible to the Internet 60b while the activation module resides on the onboard computer 42. The monitoring module 142 may generate a signal for transmission via one or more communication links or communication media to the activation module 142, whereafter the activation module 142 may signal one or more onboard components 25 to actuate disablement of the vehicle.

In still another example, both the monitoring module 140 and the activation module 142 may reside on or be associated with a remote node such as the node 60c. Upon signal form the monitoring module 140 to the activation module 142, the activation module may cause a signal to be transmitted via communication link(s) and communication media to a fleet of vehicles, causing temporary or permanent disablement of the vehicles pending situation resolution.

The alert module 144 may be used, for example, to generate a signal to emergency response teams 17a for responsive action and/or activate warning devices 62, such as a loudspeaker or sirens. The alert module 144 may be further be capable of receiving a signal, such as a signal generated by the monitoring module 140 upon determination of a deviation condition. In various aspect of the Present Invention the alert module 144 may be integrated with one or more modules, such as the activation module 142, which may, for example, receive a signal from a source and generate a signal communicated to both emergency response teams 17a and a vehicle 15.

The remobilization module 146 may provide a signal to one or more onboard components for remobilization of a vehicle or vehicle component. For example, the remobilization module 146 may reside on the node 60c may receive a signal from the monitoring module 140, and may then transmit a code via communication link(s) and communication media to the onboard computer 42 authorizing actuation of various vehicle components. One skilled in the art will appreciate that the modules of the system 138 may be configured in various combinations; may be configured in conjunction with various media; and may be utilize or interact with various combinations of Present Invention and vehicle components.

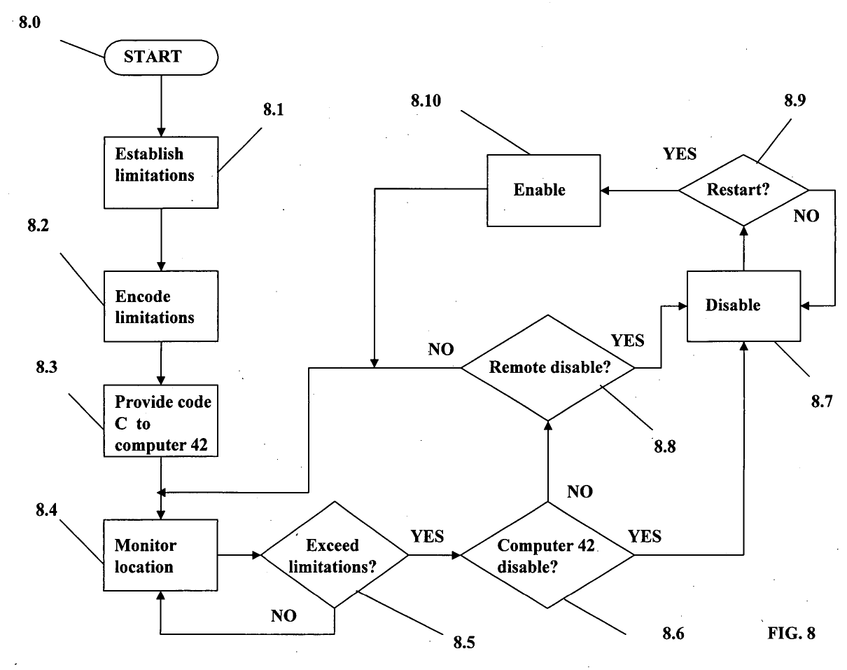

Referring now generally to the Figures, and particularly to FIGS. 1, 2, 3 and 8, FIG. 8 is a process chart comprising a flowchart of a software program that enables the control of mobility of the vehicle 15. Steps 8.0 through 8.3 are process steps applied by certain alternate preferred embodiments of the Method of the Present Invention, and steps 8.4 through 8.10 are steps of a software program S that may be executed by the computer 42 and stored in the memory 42d. In process step 8.1 geographic limitations to be applied against the mobility of the vehicle 15 are established. In process step 8.2 the geographic limitations are encoded in machine-readable software code that can be read and executed by the computer 42. In process step 8.3 the software code C is provided to the remote monitor means 14 and/or the computer 42 and integrated within the software S. In software step 8.4 the computer 42 and/or the remote monitor means 14 monitors the location of the vehicle 15. The vehicle location monitoring of step 8.4 may be accomplished by providing the computer 42 and/or the remote monitor means 14 with GPS data generated by interaction of the GPS reader 42a and the GPS system. Where the location of the vehicle 15 is determined in step 8.5 to have exceeded the geographic limitations encoded in process step 8.2, the computer 42 moves on to execute step 8.6. The determination of step 8.5 may be made be comparing GPS data provided to the computer by the GPS reader 42a to the code C. In software step 8.6 the computer 42 determines whether the software S directs the computer 42 to disable the vehicle 15, as per software step 8.7. In software step 8.8 the computer 42 determines whether the remote monitor 14 directs the computer 42 to disable the vehicle 15, as per software step 8.7. In software step 8.9 the computer 42 determines whether the software S and/or the remote monitor means 14 directs the computer 42 to re-enable the vehicle 15, as per software step 8.10.

Referring generally to the Figures and particularly FIG. 9, FIG. 9 is a detailed schematic of the computer of 42 and associated peripherals. A processor 42e executes the software S and the code C, and is communicatively coupled with elements of the computer 42 and .xx by means of an internal communications bus 42f (hereafter “comms bus 42f”). The comms bus 42f communicatively further couples processor 42e with the GPS reader 42b, the media reader 42a, the memory 42d, and the radio transceiver 43c. The radio transceiver 42c communicatively optionally couples the processor 42e with the handheld device 50 and the remote monitor means 14 and enables the computer 42 to receive software encoded commands directing the disablement and enablement of self-propelled mobility of the vehicle 15.

The comms bus 42f yet further communicatively couples the processor 42e with a plurality of interface devices 42g-j. The handheld interface 42h communicatively couples the handheld device 50 with the processor 42e and various elements of the computer 42. The relay interface 42i communicatively couples the relay 44 with the processor 42e and various elements of the computer 42. The microphone interface 42j communicatively couples the microphone/transmitter 48 with the processor 42e and various elements of the computer 42.

The foregoing disclosures and statements are illustrative only of the Present Invention, and are not intended to limit or define the scope of the Present Invention. The above description is intended to be illustrative, and not restrictive. Although the examples given include many specificities, they are intended as illustrative of only certain possible embodiments of the Present Invention. The examples given should only be interpreted as illustrations of some of the preferred embodiments of the Present Invention, and the full scope of the Present Invention should be determined by the appended claims and their legal equivalents. Those skilled in the art will appreciate that various adaptations and modifications of the just-described preferred embodiments can be configured without departing from the scope and spirit of the Present Invention. Therefore, it is to be understood that the Present Invention may be practiced other than as specifically described herein. The scope of the Present Invention as disclosed and claimed should, therefore, be determined with reference to the knowledge of one skilled in the art and in light of the disclosures presented above.

I claim:

1. A control system of a motorized vehicle, the control system comprising:
a. means for determining a geographic location of the vehicle;
b. means for comparing the location of the vehicle against a set of geographic limitation parameters; and
c. means for impairing the mobility of the vehicle, whereby movement of the vehicle is constrained when the vehicle's location exceeds at least one geographic limitation parameter.

2. The system of claim 1, wherein the means for determining the location of the vehicle comprises a GPS receiver.

3. The system of claim 1, wherein the means for comparing the location of the vehicle comprising a computational engine and computer-executable instructions, whereby the computer-executable instructions direct the computational engine to determine the location of the vehicle against a set of programmed limitations.

4. The system of claim 1, wherein the means for impairing the mobility if the vehicle includes a control device, the control device configured to controllably impede the operation of an engine of the vehicle.

5. The system of claim 1, wherein the means for impairing the mobility if the vehicle includes a control device, the control device configured to controllably deny fuel to an energy conversion module of the vehicle.

6. The system of claim 5, wherein the control device id further configured to impede a flow of a liquid fuel to the energy conversion module.

7. A control system of a motorized vehicle, the motorized vehicle having a fuel source and an energy conversion module, the control system comprising:
a. means for determining the location of the vehicle;
b. means for comparing the location of the vehicle against a set of limitation parameters; and
c. means for limiting access to fuel of the fuel source by the energy conversion module, whereby movement of the vehicle is constrained when the vehicle's location exceeds at least one parameter.

8. The system of claim 7, wherein the fuel is selected from the group consisting of gasoline, diesel, combustible vapor and electrical energy.

9. The system of claim 7, wherein the system further comprises a manual control, the manual control configured to enable a human to direct the means for limiting access to fuel to deny access to the energy conversion module.

10. A control system of a motorized vehicle, the control system comprising:
a. a controller, the controller programmed to controllably impede the mobility of the vehicle;
b. a radio transmitter, the radio transmitter for transmitting information identifying the vehicle; and
c. a radio receiver, the receiver configured to receive instructions via radio wave, the instructions for directing the controller to impede the mobility of the vehicle.

11. The system of claim 10, the controller further comprising a disabling means selected from the group consisting of means for activating an air brake of the vehicle, interrupting a power supply, means for locking a steering assembly, and means for locking an ignition system.

12. The system of claim 10, wherein the radio transmitter and the radio receiver are comprised within a radio transceiver.

13. The system of claim 10, wherein the control system further comprises a beacon, the beacon emitting a signal selected from the group consisting of a sound signal and a light signal.

14. In a motorized vehicle having a control system, the control system configured to controllably impede mobility of the vehicle, a method comprising:
a. establishing geographic boundaries for the vehicle;
b. monitoring the location of the vehicle; and
c. impeding the mobility of the vehicle when the vehicle exceeds the geographic boundaries.

15. The method of claim 14 further comprising alerting a remote site of the vehicle's location.

16. The method of claim 14 further comprising ceasing the impeding of the vehicle's mobility.

17. The method of claim 16 further comprising ceasing the impeding of the vehicle's mobility by means of wireless communication to the control system.

18. The method of claim 14 further comprising programmably altering the geographic boundaries of the vehicle.

19. The method of claim 14 further comprising programmably altering the geographic boundaries assigned to the vehicle means of wireless communication to the control system.

20. A computer-readable medium on which are stored a plurality of computer-executable instructions for performing steps (a)-(c), as recited in claim 14.
